(19) United States
(12) Patent Application Publication
(10) Pub. No.: US 2013/0126108 A1
(43) Pub. Date: May 23, 2013

(54) CORD WINDING DEVICE FOR A SCREEN, SUCH AS A WINDOW COVERING

(71) Applicant: Coulisse B.V., Enter (NL)

(72) Inventors: Bastiaan Franciscus Klein Tuente, Groenlo (NL); Ruben Hubert Jan DeVries, Zevenaar (NL); Wouter Hendriks, Enschede (NL); Harry Davids, Raalte (NL)

(73) Assignee: Coulisse B.V., Enter (NL)

(21) Appl. No.: 13/667,311

(22) Filed: Nov. 2, 2012

(30) Foreign Application Priority Data
Nov. 3, 2011 (NL) 2007713

(51) Int. Cl. B65H 75/08; E06B 9/56

(52) U.S. Cl. CPC B65H 75/08; E06B 9/56
USPC 160/319; 242/398

(57) ABSTRACT

The invention relates to a cord winding device (1) for a screen, comprising a winding roller (10) arranged for mounting on a rotational shaft of the screen, and a sleeve (20), wherein the winding roller can be received, which sleeve is arranged for mounting on a housing for the rotational shaft. The winding roller is provided with external thread for receiving the cords and the sleeve is provided with internal thread for axial displacement of the winding roller with respect to the sleeve upon rotation of the shaft. The sleeve is provided with a cord passage part with a hole for the cords. The external thread comprises spiral grooves shaped such that the grooves can receive the cords clampingly and in the sleeve at least one pressing element is arranged for pressing a cord into the groove of the external thread.

### TECHNICAL FIELD

The present invention relates to a cord winding device for the cords of a screen, such as a window covering, comprising a winding roller arranged for mounting on a rotational shaft of the screen, and a sleeve, wherein the winding roller can at least partly be received, which sleeve is arranged for mounting on a housing for the rotational shaft, wherein the winding roller at the outer surface is provided with external thread for receiving the one or more cords and wherein the sleeve on the inner surface is provided with internal thread for axial displacement of the winding roller with respect to the sleeve upon rotation of the rotational shaft, wherein the internal thread is located near an outer end of the sleeve and wherein the sleeve is provided with a cord passage part with a hole for the one or more cords, which cord passage part is arranged behind the internal thread seen in the direction of axial displacement of the winding roller with respect to the sleeve.

### BACKGROUND OF THE INVENTION

Such a cord winding device is known in the art, for example from the European Patent EP 1 536 096.

The known cord winding device comprises a winding screw that is fixedly mounted in a rail of a window covering. The sleeve is formed by a nut that is wound around the winding screw and thereby applies the cord onto the winding screw.

The known cord winding device has the advantage that the raising cords of a screen can be wound onto the winding screw without overlap.

The known cord winding device will however not function properly when the tension on the cords falls out during the lowering of the cords. When a window covering is hanging in a window frame this situation may occur when an object is standing in the window frame onto which the underside of the window covering remains lying unintentionally during the lowering. At the known cord winding device the raising cords will then unwind further as a consequence whereof the window covering will be tilted.

### DISCLOSURE OF THE INVENTION

The present invention has for its purpose to provide a cord winding device that lifts this disadvantage.

The cord winding device according to the present invention thereto is characterized in that that the external thread comprises one or more spiral grooves and the shape of the grooves is such that the grooves can receive the one or more cords clampingly. Thanks to the clamping the cord will in fact be forced out of the grooves during the unwinding, such that the unwinding will take place in a controlled manner. Even tensionless cords will thus unwind evenly.

The cord winding device according to the present invention further is characterized in that in the sleeve at least one pressing element is arranged for pressing a cord into the groove of the external thread. By pressing the cord against the bottom of the groove it is ensured that the envisaged clamping will be achieved and that the cords will be wound up tight on the winding roller.

In an elegant embodiment the pressing element is an entrenchment that is arranged near the hole for the cords in the cord passage part.

In a practical embodiment the grooves of the external thread have a generally U-shaped cross section. In general the raising cords of a screen, in particular of a window covering, have a generally round cross section. A cord with such a round cross section can be clampingly engaged in a groove with a generally U-shaped cross section.

According to a further embodiment the sleeve has a length such that at least a number of the cord windings on the winding roller is located in the sleeve. The sleeve encloses the cord windings and also forms a bearing housing for the winding roller.

According to a further development the difference between the outer diameter of the winding roller and the inner diameter of the sleeve is smaller than the thickness of the cords. In this way the cords are as effectively as possibly locked up in the sleeve, while there remains sufficient play for a reliable functioning of the cord winding device.

Preferably the inner diameter of the sleeve is substantially constant over at least a part of the length of the sleeve. This contributes to an improved bearing.

According to a compact preferred embodiment the inner thread on the sleeve substantially comprises one loop. This compact preferred embodiment can be manufactured by means of injection moulding.

The invention also relates to a screen having raising cords, such as a window covering, comprising a housing, wherein a rotational shaft is arranged, characterized in that the screen further comprises a cord winding device according to the present invention.

The invention will now be described in more detail referring to the figures.

### BRIEF DESCRIPTION OF THE DRAWINGS

FIG. 1 shows a schematic view of a system for window covering provided with a preferred embodiment of the cord winding device according to the invention;

FIG. 2 shows the cord winding device of FIG. 1 in exploded view;

FIGS. 3A and 3B show the cord winding device of FIG. 1 in a first position, respectively in a schematic partial view and in a cross sectional view;

FIGS. 4A and 4B show the cord winding device of FIG. 1 in a second position, respectively in a schematic partial view and in a cross sectional view;

FIG. 5 shows a part of the cord winding device of FIG. 1 schematically in more detail; and

FIG. 6 shows a cross section of a part of the system of FIG. 1; and

FIG. 7 shows a part of FIG. 6.

### BEST MODE FOR CARRYING OUT THE INVENTION

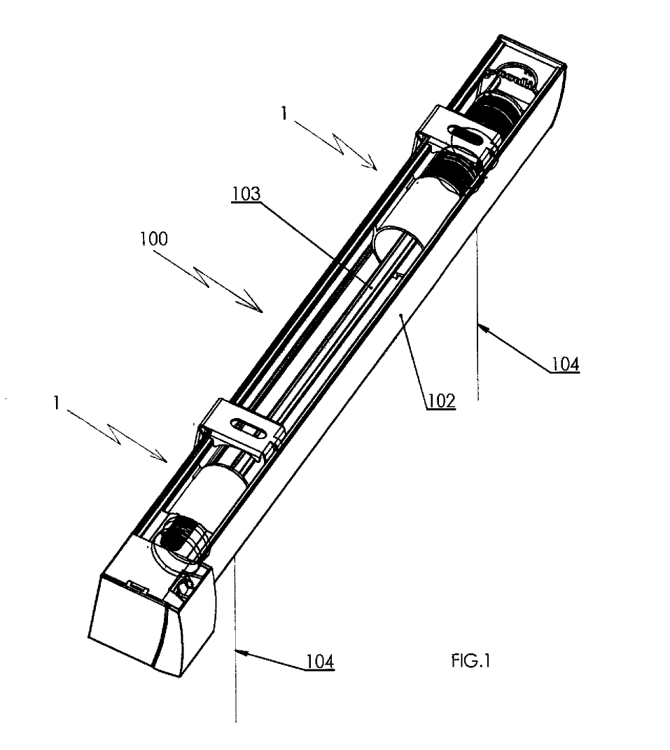

FIG. 1 shows a system of a window covering 100 provided with a preferred embodiment of a cord winding device 1 according to the present invention. System 100 is provided with an elongate housing 102. The elongate housing or rail 102 serves for mounting the system 100 to a wall or ceiling.

In the elongate housing 102 a shaft 103 extends that is intended for rotation in the housing 102. On the shaft 103 one or more cord winding devices 1 are coaxially mounted for winding up and unwinding the raising cords 104, that extend through the covering (not shown).

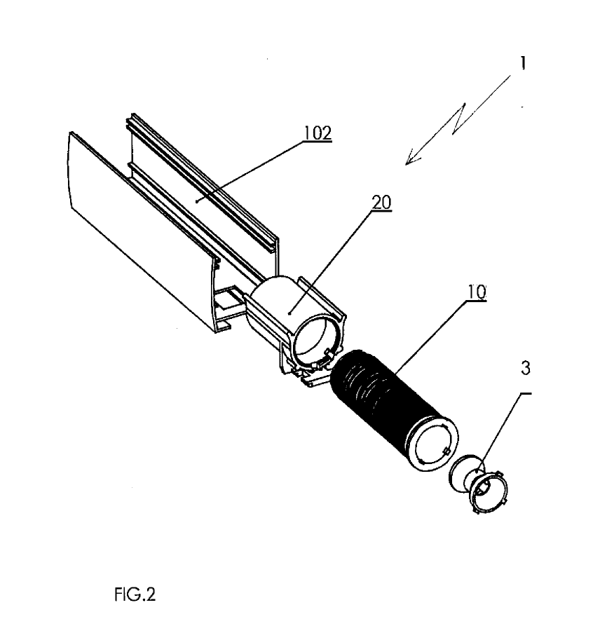

FIG. 2 shows the cord winding device 1 in exploded view. The cord winding device 1 comprises a winding roller 10 and a sleeve 20 for at least partly receiving the winding roller 10. Sleeve 20 is intended to be mounted in rail 102. Winding roller 10 is intended to be coaxially mounted on rotational shaft 103. In the preferred embodiment shown for this purpose a shaft adapter 3 is provided. Winding roller 10 is on the outer surface provided with external thread 11. Sleeve 20 is on the inner surface provided with inner thread 21. By rotation of shaft 103 an axial displacement in the direction A takes place of winding roller 10 with respect to sleeve 20 by cooperation of the external thread 11 and the internal thread 21.

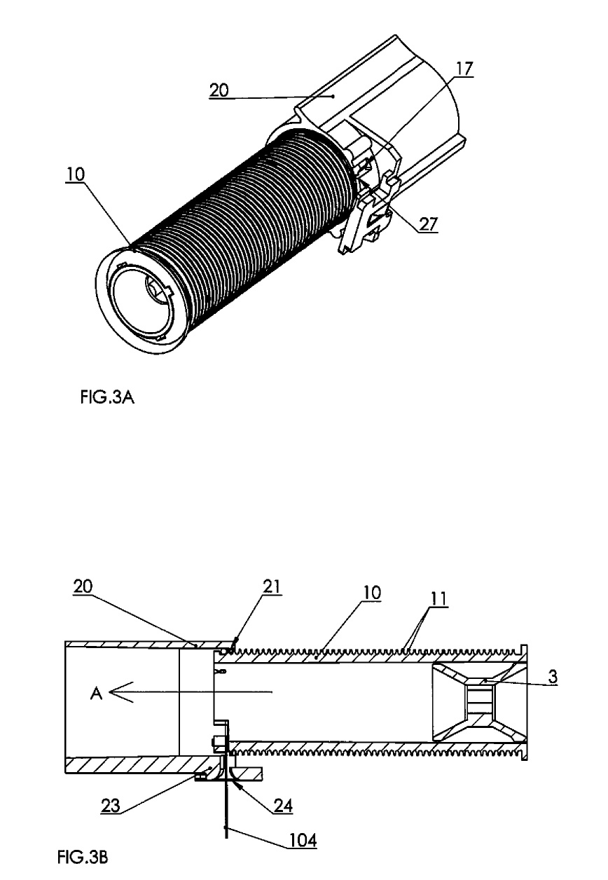

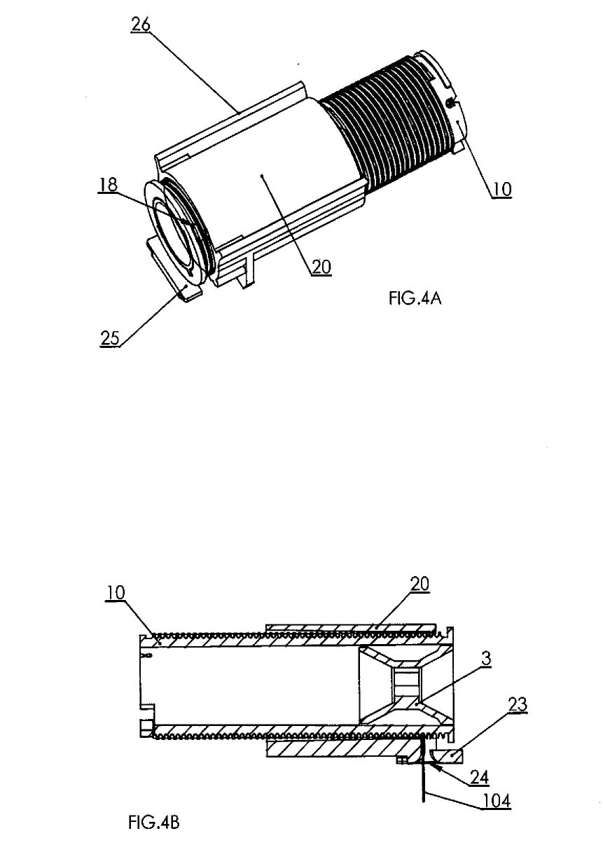

FIG. 3A shows a schematic partial view of the cord winding device 1 in a first position. FIG. 3B shows a longitudinal cross section through the cord winding device 1 in the first position. FIG. 4A shows a schematic partial view of the cord winding device 1 in a second position. FIG. 4B shows a longitudinal cross section through the cord winding device 1 in the second position.

In the first position the cord 104 is unwound and the window covering (not shown) is in the lowest position. Winding roller 10 and sleeve 20 are provided with a click mechanism that is formed by a clicker 17 on winding roller 10 and a cooperating recess 27 on sleeve 20. By means of this click mechanism the winding roller 10 is prevented from being screwed out of sleeve 20.

The external thread 11 on winding roller 10 is formed by at least one spiral or helix groove. According to the invention the groove has such a shape that the groove can receive cord 104 at least substantially clampingly. Preferably the groove is in cross section generally U-shaped. In practice raising cords of screens normally have a generally round shape that can be received slightly clampingly in the U-shape of the thread 11. The sleeve 20 is close to an outer end provided with the internal thread 21 that comprises one or more loops or screw threads.

Sleeve 20 is provided with a cord passage part 23, wherein a hole 24 is located for the cord 104. The cord 104 is detachably attached in a suitable manner to winding roller 10 preceding the assembly of winding roller 10 in sleeve 20. By rotation of winding roller 10 an axial displacement in the direction A takes place until the cord winding device has occupied a second position that is shown in FIGS. 4A and 4B. Naturally winding roller 10 can also occupy any position between the first position and the second position.

As seen in axial direction A the hole 24 is located behind loop 21. Consequently loop 21 runs ahead of the cord 104 during the winding up. The cord 104 follows as it were loop 21 and fills the spiral groove.

Winding roller 10 is at the other outer end provided with an end stop 18. This determines the second position of winding roller 10 with respect to sleeve 20. In the second position it can clearly be seen that the cord 104 is wound up tight and without overlap on winding roller 10.

Sleeve 20 has a length such that at least a number of the cord windings on the winding roller 10 are located in the sleeve 20. The sleeve 20 can extend over the entire length of winding roller 10 as well as over a part thereof. The difference between the outer diameter of the winding roller 10 and the inner diameter of the sleeve 20 is smaller than the thickness of the cord 104. This difference is also larger than zero. Consequently there exists some play between the sleeve 20 and the winding roller 10. The sleeve 20 forms a bearing housing for the winding roller 10. Preferably the inner diameter of the sleeve 20 is substantially constant over at least a part of the length thereof. The remaining part of the sleeve may have a larger inner diameter to support releasing action.

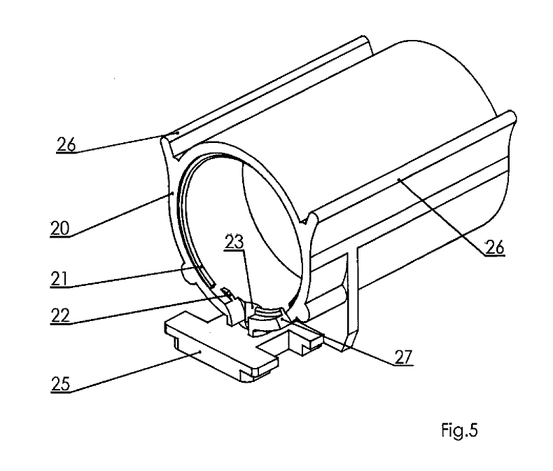

FIG. 5 shows a part of sleeve 20 in more detail. Herein it can be seen that adjacent to hole 24 a pressing element 22 is arranged. The pressing element 22 is located behind loop 21 as seen in axial displacement direction A. The pressing element 22 is formed as a ramp or entrenchment and presses the cord 104 against the bottom of groove 11. The groove 11 is shaped such that the cord 104 can be clampingly received at the location of the bottom. In the preferred embodiment illustrated cord 104 has a generally round cross section and groove 11 has a generally U-shaped cross section. The right legs of the U-shape contribute to the clamping of the cord 104.

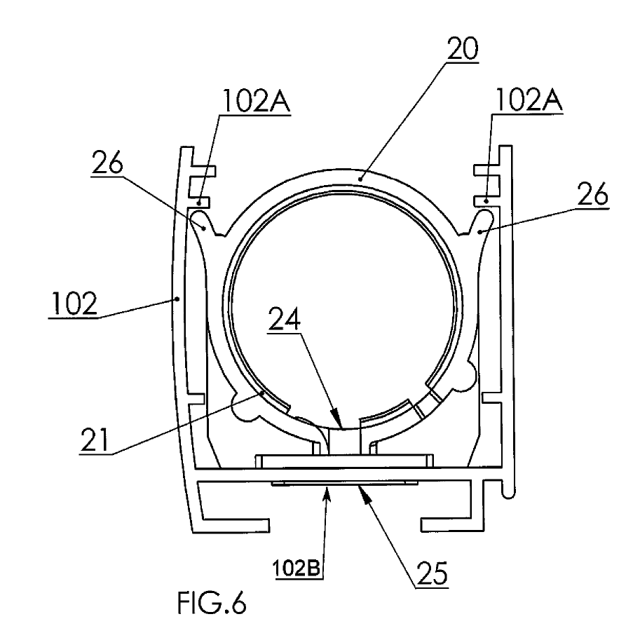

FIG. 6 shows a cross section through a part of the system 100 of FIG. 1. Herein it can be seen how sleeve 20 is mounted in rail 102. Sleeve 20 is provided with raised edges 26 and a pilot element 25. Rail 102 is provided with protruding edges 102A and a hole 102B. The protruding edges 102A are intended for cooperation with the raised edges 26 of sleeve 20. The hole 102B in the bottom of rail 102 serves for receiving the pilot element 25. Sleeve 20 needs to be mounted fixated against rotation in rail 102. The way of mounting illustrated in FIG. 6 is only intended for illustrative purposes.

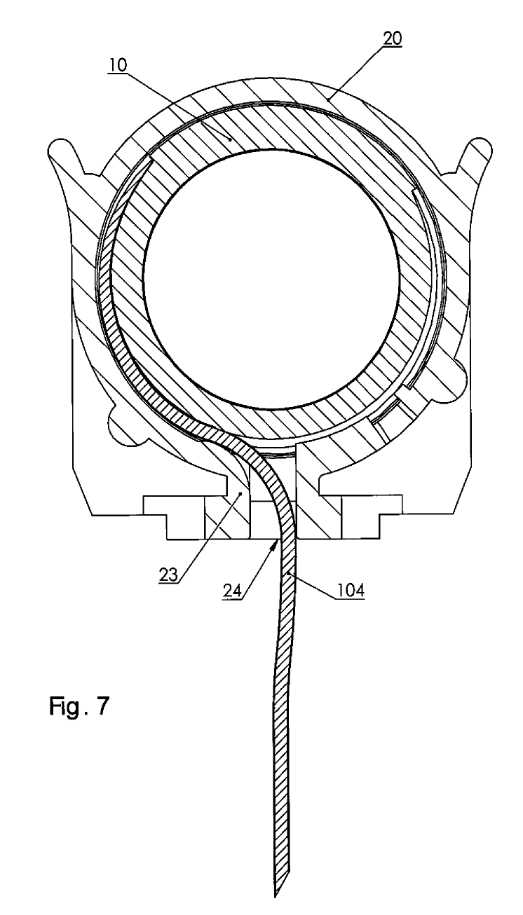

FIG. 7 shows a part of FIG. 6 to illustrate the unwinding of the cord. By counter rotation of winding roller 10 in sleeve 20 the cord 104 is unwound through the hole 24 in the cord passage part 23. The cord will be unwound in a tight manner due to the length of the passageway of the hole 24 and the natural stiffness of the cord 104.

In the preferred embodiment shown one spiral groove 11 is present on winding roller 10 and one loop or thread of screw 21 is present on sleeve 20 with adjacent hole 24 and pressing element 22. In this embodiment the cord winding device 1 is arranged for winding up one cord. In order to make the cord winding device 1 suitable for simultaneously winding up more, for example two, cords for each cords a spiral groove should be arranged on the winding roller as well as at least one loop or thread of screw on the sleeve and a hole and for each cord an adjacent pressing element on the sleeve. The hole can be a joint hole or there can be a separate hole for each cord. More cords can then be wound up simultaneously.

The cord winding device according to the present invention is in general applicable for winding up and unwinding the cords of a screen such as a window covering. Examples of window covering having raising cords are pleated curtains, venetian blinds and folding blinds.

It is noted that in the context of the present invention by cords all suitable thin longitudinal raising means for a screen are meant. A practical example of an alternative for cords is for instance straps. According to the inventive thought the shape of the grooves should then be arranged to receive the straps clampingly. To receive the straps clampingly the grooves should have a substantially rectangular cross section. The shape of the groove corresponds at least in part to the shape of the raising means such that the grooves receive the raising means substantially clampingly. The clamping is achieved by choosing mating shapes.

The invention is of course not limited to the described preferred embodiment but extends to any embodiment falling within the scope of the protection as defined in the claims and as seen in the light of the foregoing description and accompanying drawings.

1. A cord winding device for the cords of a screen, such as a window covering, comprising a winding roller arranged for mounting on a rotational shaft of the screen, and a sleeve, wherein the winding roller can at least partly be received, which sleeve is arranged for mounting on a housing for the rotational shaft, wherein the winding roller at the outer surface is provided with external thread for receiving the one or more cords and wherein the sleeve on the inner surface is provided with internal thread for axial displacement of the winding roller with respect to the sleeve upon rotation of the rotational shaft, wherein the internal thread is located near an outer end of the sleeve and wherein the sleeve is provided with a cord passage part with a hole for the one or more cords, which cord passage part is arranged behind the internal thread seen in the direction of axial displacement of the winding roller with respect to the sleeve, characterized in that the external thread comprises one or more spiral grooves and the shape of the grooves is such that the grooves can receive the one or more cords clampingly and in that in the sleeve at least one pressing element is arranged for pressing a cord into a groove of the external thread.

2. A cord winding device according to claim 1, wherein the pressing element is an entrenchment that is arranged near the hole for the cords in the cord passage part.

3. A cord winding device according to claim 1, wherein the grooves of the external thread have a generally U-shaped cross section.

4. A cord winding device according claim 1, wherein the sleeve has a length such that at least a number of the cord windings on the winding roller is located in the sleeve.

5. A cord winding device according to claim 4, wherein the difference between the outer diameter of the winding roller and the inner diameter of the sleeve is smaller than the thickness of the cords.

6. A cord winding device according to claim 1, wherein the inner diameter of the sleeve is substantially constant over at least a part of the length of the sleeve.

7. A cord winding device according to claim 1, wherein the internal thread on the sleeve substantially comprises one loop.

8. A screen having raising cords, such as a window covering, comprising a housing, wherein a rotational shaft is arranged, characterized in that the screen further comprises a cord winding device according to claim 1.
